(19) United States
(12) Patent Application Publication
(10) Pub. No.: US 2022/0042917 A1
(43) Pub. Date: Feb. 10, 2022

(54) REMOTE-EXCITATION TIP-ENHANCED RAMAN SPECTROSCOPY (TERS) PROBE FOR NANOSCALE TERS IMAGING

(71) Applicant: THE REGENTS OF THE UNIVERSITY OF CALIFORNIA, Oakland, CA (US)

(72) Inventors: Ming LIU, Riverside, CA (US); Ruoxue YAN, Riverside, CA (US); Xuezhi MA, Riverside, CA (US)

(73) Assignee: THE REGENTS OF THE UNIVERSITY OF CALIFORNIA, Oakland, CA (US)

(21) Appl. No.: 17/297,930

(22) PCT Filed: Nov. 15, 2019
(86) PCT No.: PCT/US2019/061720

§ 371 Date: May 27, 2021

Related U.S. Application Data
(60) Provisional application No. 62/772,459, filed on Nov. 28, 2018.

(51) Int. Cl. G01N 21/65; G01Q 60/38

(52) U.S. Cl. CPC G01N 21/658; G01N 2201/0633; G01N 2201/06113; G01Q 60/38

(57) ABSTRACT

A method is disclosed for spatial resolution tip-enhanced Raman spectroscopy (TERS) imaging. The method includes physically separating a light excitation region from a Raman signal generation region on a remote-excitation tip-enhanced Raman spectroscopy (RE-TERS) probe. Also disclosed is a method of fabricating a remote-excitation tip-enhanced Raman spectroscopy (TERS) probe, and a system for spatial resolution tip-enhanced Raman spectroscopy (TERS) imaging. The system includes an atomic force microscopy-tip-enhanced Raman spectroscopy (AFM-TERS) system having a RE-TERS probe having a conical tip tapering to a silver nanowire tip (AgNW tip), a silver nanocrystal (AgNC) attached to a side wall of a nanowire, a laser configured to propagate excited surface plasmon polaritons (SPPs) along the nanowire, the nanowire (NW) configured to generate compressed excited surface plasmon polaritons (SPPs), and wherein the conical tip of the nanowire is configured to generate a nano-sized hot spot at a tip apex for TERS excitation.

### CROSS-REFERENCE TO RELATED APPLICATION

This application claims priority to U.S. Provisional Application No. 62/772,459, filed Nov. 28, 2018, the entire content of which is incorporated herein by reference.

### GOVERNMENT CLAUSE

This invention was made with government support under grants 1654746 and 1654794 awarded by the National Science Foundation. The government has certain rights in the invention.

### TECHNICAL FIELD

The disclosure generally relates to a method and system toward high-contrast atomic force microscopy tip-enhanced Raman spectroscopy (AFM-TERS) imaging with nano-antenna-mediated remote-excitation on sharp-tip silver nanowire probes.

### BACKGROUND

The tip-enhanced Raman spectroscopy (TERS) imaging technique is designed to provide correlated morphological and chemical information with a nanoscale spatial resolution by utilizing the plasmonic resonance supported by metallic nanostructures at the tip apex of a scanning probe. However, limited by the scattering cross-sections of these nanostructures, only a small fraction of the incident light can be coupled to the plasmonic resonance to generate Raman signals. The uncoupled light then directly excites background spectra with a diffraction-limited resolution, which becomes the background noise that often blurs the TERS image.

### SUMMARY

In accordance with an exemplary embodiment, a method and system are disclosed for remote-excitation tip-enhanced Raman spectroscopy (TERS) probe for nanoscale TERS imaging by physically separating the light excitation region from the Raman signal generation region on the scanning probe. The remote-excitation TERS (RE-TERS) probe, which can be fabricated with a facile, robust and reproducible method, utilizes silver nanoparticles as nano-antennas to mediate the coupling of free-space excitation light to propagating surface plasmon polaritons (SPPs) in a sharp-tip silver nanowire to excite Raman signals remotely. With this RE-TERS probe, a 10 nm spatial resolution was demonstrated on a single-walled carbon nanotube (SW-CNT) sample, and the strain distribution in a monolayer molybdenum disulfide (MoS₂) was mapped.

In accordance with an exemplary embodiment, a method is disclosed for spatial resolution tip-enhanced Raman spectroscopy (TERS) imaging, the method comprising: physically separating a light excitation region from a Raman signal generation region on a remote-excitation tip-enhanced Raman spectroscopy (RE-TERS) probe.

In accordance with another exemplary embodiment, a method is disclosed of fabricating a remote-excitation tip-enhanced Raman spectroscopy (TERS) probe, the method comprising: fabricating the remote-excitation tip-enhanced Raman spectroscopy (TERS) probe with nanoparticles as nano-antennas to mediate coupling of free-space excitation light to propagate surface plasmon polaritons (SPPs) in a tapered-tip silver nanowire to remotely excite Raman signals.

In accordance with an a further exemplary embodiment, a system is disclosed for spatial resolution tip-enhanced Raman spectroscopy (TERS) imaging, the system comprising: an atomic force microscopy-tip-enhanced Raman spectroscopy (AFM-TERS) system, the AFM-TERS system having a RE-TERS probe having a conical tip, the conical tip tapering to a silver nanowire tip (AgNW tip); a silver nanocrystal (AgNC) attached to a side wall of a nanowire (NW) at an incident angle; a laser, the laser configured to propagate excited surface plasmon polaritons (SPPs) along the nanowire (NW), the nanowire (NW) configured to generate compressed excited surface plasmon polaritons (SPPs), and wherein the conical tip of the nanowire (NW) is configured to generate a nano-sized hot spot at a tip apex for TERS excitation; and an object lens configured to collect a TERS signal scattered by the silver nanowire tip (AgNW tip).

### BRIEF DESCRIPTION OF DRAWINGS

FIGS. 1(a)-1(e) are illustrations of a remote-excitation tip-enhanced Raman spectroscopy (RE-TERS), where FIG. 1(a) is a schematic illustration of the RE-TERS setup. The green excitation laser beam (532 nm) is sent through a laser line filter (LF), a linear polarizer (LP) and a beam splitter (BS) to an objective lens, which focuses the excitation laser beam on an AgNC to excite SPPs on the AgNW waveguide. The SPPs propagate toward the tapered tip to excite TERS signals, which are collected through the same objective lens, filtered by a long-pass edge filter (LEF) and collected by a CCD spectrometer; FIG. 1(b) is a SEM image of a RE-TERS probe; FIGS. 1(c) and 1(d) are close-up SEM images of the AgNC-AgNW junction FIG. 1(c) and sharp AgNW tip FIG. 1(d); and FIG. 1(e) is an image obtained in bright field optical microscopy showing the coupling between the 532 nm excitation laser beam (polarization along the green arrow) and the AgNC-AgNW junction coupler (red arrow). The yellow arrow marks the position of the AgNW tip.

FIGS. 2(a)-2(h) are illustrations of RE-TERS mapping of a CVD-grown MoS₂ monolayer flake, where FIG. 2(a) is an AFM image of the MoS₂ flake on an ultra-smooth gold substrate, with the line-scan shown in FIG. (b), and wherein the makers indicate the edge of the MoS₂ flake (green) and two wrinkles (light blue and orange); FIGS. 2(c)-2(f) illustrates TERS mapping of the intensities, I (c and e, in counts per second, ct/s) and the Raman shifts, v (d and f) of the E¹_{2g} and A_{1g} peaks of the MoS₂ flake, respectively; and FIG. 2(g)-2(h) illustrate stress-induced Raman peak shifts in MoS₂ monolayer, the bottom panel of FIG. 2(g) shows the inter-peak spacing, Δ\tilde{v}, between the E_{2g}¹ and A_{1g} peaks, which changes from ˜18 cm⁻¹ at the center to −20.5 cm⁻¹ along the edge of the flake, and a series of eleven spectra FIG. 2(h) taken along the red arrow in FIG. 2(g) shows the shifting of both peaks and the splitting of the E¹_{2g} peak towards the edge of the flake (#1 and #11), which is the consequence of the increased tensile stress at the edge as shown in the schematic in the top panel of FIG. 2(g), and wherein excitation: 532 nm, 0.1 mW at sample surface. Integration time=1 s.

FIGS. 3(a)-3(f) illustrate the RE-TERS mapping of single-walled CNTs, sprayed on an ultra-smooth Au substrate, wherein FIG. 3(a) illustrates AFM morphology imaging, FIG. 3(b) illustrates D-band, FIG. 3(d) illustrates G-band, and FIG. 3(f) illustrates 2D-band intensity images, and wherein the spatial steps are 10 nm for top images and 4 nm for the zoom-in at bottom FIG. 3(c) and FIG. 3(e) are line cross-section of the marked regions in FIG. 3(d) and FIG. 3(b), and wherein for all TERS mapping, Excitation: 532 nm, 0.1 W at sample surface. Integration time=1 s.

FIGS. 4(a)-4(d) illustrates optimization of the RE-TERS coupling efficiency, wherein FIG. 4(a) illustrates a schematic diagram showing the parameters used to optimize in numerical simulations. The laser beam maintains a 65° incident angle with respect to the AgNW, as restricted by the equipment, while it can rotate around the AgNW (green arrow) and change the coupling angle (ϕ). The orientation of the s- and p-polarizations are marked by the navy blue and orange arrows, FIG. 4(b) illustrates numerical simulations showing the coupling efficiency (%) as functions of incident light wavelength (450˜800 nm) and AgNC size (20˜300 nm) for both s- (top) and p- (bottom) polarizations. The green dashed line marks the laser wavelength (532 nm) used in the experiments, with the profiles shown in FIG. 4(c), and FIG. 4(d) illustrates coupling efficiency dependence on the coupling angle (ϕ) for both polarizations.

FIG. 5(a)-5(e) are illustrations of a comparison between RE-TERS with DE-TERS and dependence of RE-TERS signals on tip-to-substrate distance, wherein FIGS. 5(a)-5(b) are schematics showing the remote FIG. 5(a) and direct FIG. 5(b) excitation methods, and wherein in both cases, s- and p-polarizations were examined on a self-assembled monolayer (SAM) of 4-ATP on an ultra-smooth Ag substrate, FIGS. 5(c)-5(d) are 4-ATP Raman spectra measured with RE- and DE-TERS with incident lasers with s-FIG. 5(c) and p-FIG. 5(d) polarizations in both engaged (light color, solid lines) and retracted (dark color, dashed lines) modes, and wherein FIG. 5(e) illustrates as tip gets closer to the 4-ATP SAM sample, the overall signal increases drastically (s-polarization), and at large tip-substrate distances, the peaks marked by blue arrows (1089 cm⁻¹ and 1593 cm⁻¹) have the highest intensities, consistent with regular SERS spectrum, whereas at smaller distances, the peaks marked by the red arrows (1156 cm⁻¹ and 1450 cm⁻¹) become dominating. Excitation: 532 nm, 0.2 mW at sample surface, and wherein the integration time=2 s for FIGS. 5(c)-5(d) and 4s for FIG. 5(e).

FIG. 6(a) is a schematic diagram of coupling efficiency measurement. Inset: side-view of the AgNW. Strong light scattering was found at the tip (light-blue arrow) when remotely excited (red arrow), FIG. 6(b) is illustration of excitation location dependence of the AgNW tip radiation and the coupling efficiency estimation using 532 nm, 633 nm and 671 nm laser for another probe, and FIG. 6(c) illustrates the comparison of simulated and estimated coupling efficiency.

FIGS. 7(a)-7(b) illustrate frequency of AgNCs attached on AgNW, and wherein inset FIG. 7(a) and FIG. 7(b) are SEM images of AgNC-AgNW bundles with low and high AgNC densities.

FIGS. 8(a)-8(b) are screenshots from a video, which explain the removing process, and wherein FIG. 8(a) and FIG. 8(b) show before and after AgNCs wiped off by the tungsten probe.

FIG. 9(a) illustrates the A_{1g} Ramen peak mapping of MoS₂ flake supported on Au substrate. The image contains 80 by 64 pixels over 4 μm by 3.2 μm areal, wherein in FIG. 9(b), the blue line is the Raman intensity line scan along the white dashed line from A to A′, where the red line is profile of the line scan by performed a step function fitting, in FIG. 9(c), the first derivative of the line fit in FIG. 9(b) is shown, and wherein the FWHM shows the spatial resolution of 41 nm.

FIG. 10 shows the relationship between the contact-mode AFM set point and the tip-substrate distance, and wherein the tip-to-substrate distance can be controlled by varying the set point.

FIGS. 11(a)-11(f) illustrate E_{Z} distribution at the apex of an AgNW with the coupled 532 nm laser by the AgNW-AgNC coupler, the excitation light is sent in along the green arrow, wherein FIG. 11(a) is s-, and FIG. 11(b) p-polarization excited, respectively, and wherein the electrical field distribution in the gap between sharp-tip AgNW with 5 nm diameter tip and surface of silver sample, FIG. 11(c) and FIG. 11(d) at the apex of a sharp-tip AgNW with 5 nm diameter, FIG. 11(e) and FIG. 11(f) in the gap between regular tip AgNW with 50 nm diameter tip and surface of silver sample, and wherein the gaps are 1 nm.

FIGS. 12(a)-12(d) illustrate a dark-field image of a fresh AgNW at the edge of the silicon wafer, wherein FIG. 12(a) illustrates when it was fresh and FIG. 12(b) is after 5 days of aging in air at the room temperature, FIGS. 12(c) and 12(d) are the images with changed brightness range corresponding to FIGS. 12(a) and 12(b), respectively, FIGS. 12(e) and 12(f) are the SEM image for zoomed-in details, and FIGS. 12(g) and (h) are zoomed-in dark-field image of FIGS. 12(c) and 12(d), respectively.

FIGS. 13(a)-13(d) illustrate the size distribution and SEM images of different sized AgNCs, wherein FIG. 13(a) is 100 nm AgNC, FIG. 13(b) is 180 nm AgNCs, FIG. 13(c) is 150 nm AgNCs, and FIG. 12(d) is 220 nm AgNCs, and all scale bars are 1 μm.

FIG. 14(a) illustrates the distribution of diameter of sharp-tip AgNWs, and FIGS. 14(b) and 14(c) are SEM images of the sharp-tip AgNWs.

FIG. 15 illustrates the AgNW protruding length on the cantilever adjusted by the micromanipulator.

FIG. 16 illustrates the intensity data of 4-ATP Raman peak from different RE-TERS probes.

FIG. 17(a) is a close-up schematic illustrating the remote-excitation scheme, wherein the black arrow shows the direction of SPP prorogation along the AgNW upon excitation of the incident laser on the AgNC, FIG. 17(b) is a comparison of the MoS₂ Ramen spectra measured with RE-TERS vs. conventional confocal Raman, and wherein the RE-TERS spectrum features a larger signal-to-noise ratio, indicating the selectivity towards the A_{1g} peak, and wherein FIGS. 17(c) and 17(d) are numerical simulations showing the strength and spatial distribution of the E-field components that are perpendicular (E_{⊥}, FIG. 17(c) and parallel (E_{∥}, FIG. 17(d) to the substrate at the tip apex, and wherein the E_{⊥} component selectively drives the out-of-plane A_{1g} vibration, whereas the E_{∥} drives the in-plane E¹ vibration more effectively.

### DETAILED DESCRIPTION

In accordance with an exemplary embodiment, compared with other TERS techniques, grating-assisted nanofocusing skips the noise reduction steps, such as the background subtraction method or the modulation method, and has been used in a broad spectrum of research topics, ranging from optical nano-imaging, Raman analysis, to nanoscale ultrafast optics. However, the reproducibility of the grating-assisted probes has been the primary challenge to this technique. For example, annealed gold wires, which are the preferred material for fabricating grating-assisted probes due to their high crystallinity and low plasmonic loss, suffer from the low mechanical stiffness as a result of the annealing. The intricate balance between the mechanical stiffness and optical quality of the gold wires requires meticulous control over annealing conditions. Equally tricky is the precise control over the electrochemical etching process used to taper the nanowire (NW) tip, the exact geometry and surface roughness of which is critical for the efficiency of plasmonic nanofocusing and TERS enhancement.

In accordance with an exemplary embodiment, compared with gold, silver can be more favorable for TERS experiments due to its stronger plasmonic enhancement and lower fluorescence background. Chemically synthesized crystalline silver nanowires (AgNWs), in particular, is uniquely suited for TERS, due to their nanoscale field confinement, mechanical robustness and low plasmonic loss, the latter of which both stemming from their poly-twined crystalline nature. In addition, AgNW SPPs can be excited easily using a variety of methods, from prism or grating couplers, near-field coupling, to as simple as tip, defect and nano-antenna scattering, making them uniquely suited for remote-excitation TERS as an easy alternative to the grating-assisted nanofocusing technique.

Recently, the synthesis of AgNWs that have ultra-sharp conical tips with nanometer-scale tip curvature has been reported, and their integration with commercial AFM probes for topographical imaging. In the present disclosure, it is demonstrated that high-resolution remote-excitation TERS imaging can also be realized with an AFM mounted sharp-tip AgNW. This RE-TERS probe can utilize nanoparticles, for example, colloidal silver nanocubes (AgNCs) attached to the AgNW probe to couple visible light into SPPs on the latter. In accordance with an alternative embodiment, the nanoparticles, can be, for example, dielectric particles. Benefiting from the low plasmonic loss of the free-standing AgNW at the visible wavelengths, the propagation loss of SPPs along the NW can be maintained at less than 1 dB when the AgNC is placed only a few microns away from the tip apex. In accordance with an exemplary embodiment, the conical taper at the AgNW tip leads to the further compression of SPPs modes and the generation of a plasmonic hot spot at the tip apex to allow high spatial resolution TERS imaging. Adding to the inherent low background noise of the remote-excitation scheme, the AgNC antenna is insensitive to the polarization of the incident light, which allows the use of linearly polarized light with the electric field parallel to the metallic substrate to further reduce the background Raman noise from stray beams. With the AgNC-AgNW RE-TERS probe, it is demonstrated the TERS imaging of monolayer molybdenum disulfide (MoS₂) domains and estimated the spatial resolution around 41 nm and TERS contrast around 100. In accordance with an exemplary embodiment, the spatial resolution can be further pushed, for example, to approximately 10 nm when a single-walled carbon nanotube (SW-CNT) sample is characterized.

### Results and Discussion

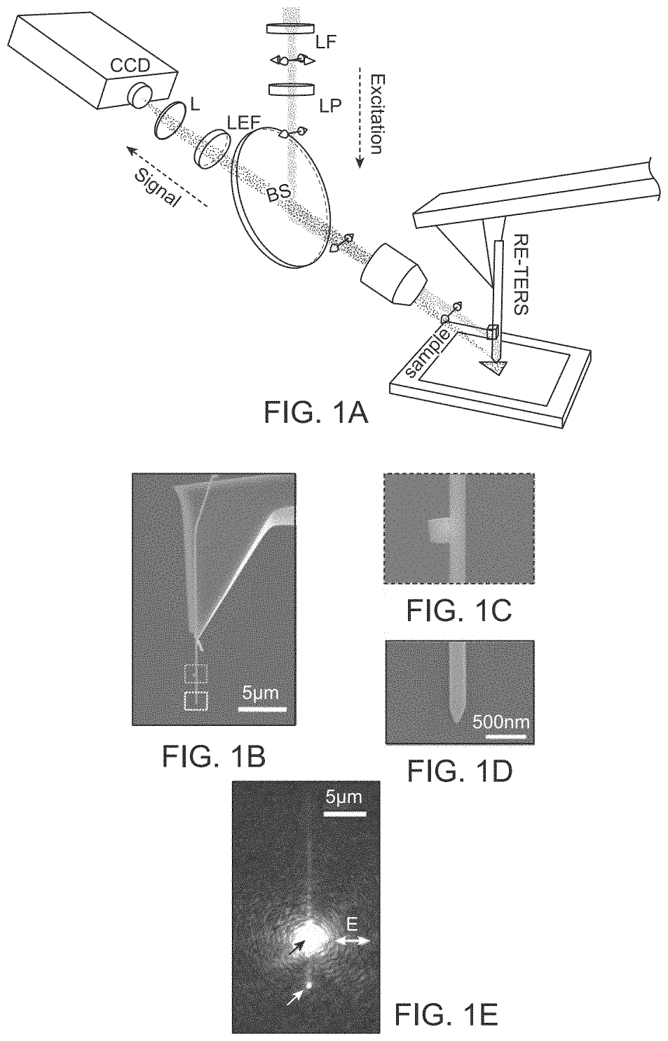

In accordance with an exemplary embodiment, as illustrated in FIG. 1(a), the RE-TERS probe was installed on a commercial AFM-TERS system (SmartSPM™ 1000, AIST-NT) with modifications to enable polarization adjustment of the incident laser. To launch the SPPs into the AFM-mounted AgNW probe, a linearly polarized laser (532 nm, s-polarization) was focused on the AgNC attached to the side wall of a NW at an incident angle, for example, of approximately 25° by a microscope objective (100×) with a numerical aperture (NA) of 0.7 and a long working distance of 6 mm. The excited SPPs propagate along the NW and get further compressed by the conical geometry of the NW tip to generate a nano-sized hot spot at the tip apex for TERS excitation. The TERS signal scattered by the AgNW tip is then collected through the same objective lens. To maintain the remote-excitation condition, the NC needs to be at least several micrometers away from the NW tip (FIG. 1(b)), so that the tip sits well outside the laser focus (approximately 1 μm×0.9 μm). By raising the laser focus away from the sample and choosing the s-polarization for excitation, the background noise from direct illumination of the sample is minimized.

In accordance with an exemplary embodiment, AgNCs were prepared according to a previously reported polyol synthesis method with slight modification. These AgNCs display high size monodispersity and have an edge length, for example, of approximately 200 nm (FIG. 1(c)). Sharp-tip AgNWs were synthesized following the method reported in Ma, X. Z.; Zhu, Y. Z.; Kim, S.; Liu, Q. S.; Byrley, P.; Wei, Y.; Zhang, J.; Jiang, K. L.; Fan, S. S.; Yan, R. X.; Liu, M. Nano Letters 2016, 16, (11), 6896-6902. The crystalline AgNW has smooth surfaces that minimize the propagation loss to approximately 0.4 dB/μm for the 200 nm-in-diameter AgNW used in FIG. 1(b). Given an average of approximately 3 μm distance between the AgNC and the AgNW tip, the propagation loss of the SPPs was around 1.2 dB. The conical tip tapered to an ultra-sharp apex (tip radius approximately 15 nm, FIG. 1(d)). The AgNC-AgNW bundle was fabricated by incubating a mixture of AgNW and AgNC colloidal solutions for 12 hours (hrs), during which AgNCs self-assembled on the AgNW surface and the density was adjusted by their relative concentrations. The mixture was then drop-casted on a polydimethylsiloxane (PDMS) substrate, from which a single AgNC-AgNW bundle was picked up with a tungsten tip mounted on a micromanipulator. Any excess AgNCs were removed by gently wiping the AgNW with the tungsten tip before picking it up (See SI-Video for the demonstration). Then, the AgNC-AgNW bundle with a single AgNC was assembled to the sidewall of the pyramidal tip of a conventional silicon AFM cantilever (Olympus, Model #AC160TS-R3), as shown in FIG. 1(b), which procedure has been demonstrated as a relatively simple yet effective fabrication method to prepare high-resolution, high aspect-ratio AFM probes with relatively good stability and performance. The adhesion between a clean AgNW and the silicon tip is sufficient for both AFM tapping mode and contact mode operations. As shown in FIG. 1(e), when a laser beam is tightly focused on the AgNC (marked by the red arrow), the light coupled out from the AgNW tip 6 μm away from the laser appears clearly as a bright spot (marked by the yellow arrow), demonstrating the successful launching of AgNW SPPs and their propagation to the tip apex. It is worth noting that both the colloidal AgNCs and sharp-tip AgNWs are synthesized in milliliter to liter volumes and the probe fabrication process can be completed under an optical microscope without the need for cost-consuming equipment such as focused ion beam (FIB) etching.

In accordance with an exemplary embodiment, the RE-TERS probe was used to study the strain field on a stressed MoS₂ monolayer flake, for the demonstration of its high-resolution low-background Raman imaging. Raman spectroscopy and microscopy is one of the most powerful tools to study strain and strain distributions in materials, and TERS allows for the visualization of localized strain field with nanoscale resolution. Such nanoscale strain characterization capability is extremely important for the micro- and nanoscale strain engineering in MoS₂ and other transition metal dichalcogenides, whose bandgap and optoelectronic properties can be tuned by applying strains. Recently, TERS has been used to probe the strain field of trilayer and monolayer MoS₂ deposited on Au nanocluster arrays, taking advantage of the giant SERS effect from the localized surface plasmon of Au nanoclusters. However, high-resolution TERS strain mapping on a pre-stressed MoS₂ flake on an ultra-smooth substrate with minimal structural, optical and thermal inhomogeneity has not yet been demonstrated.

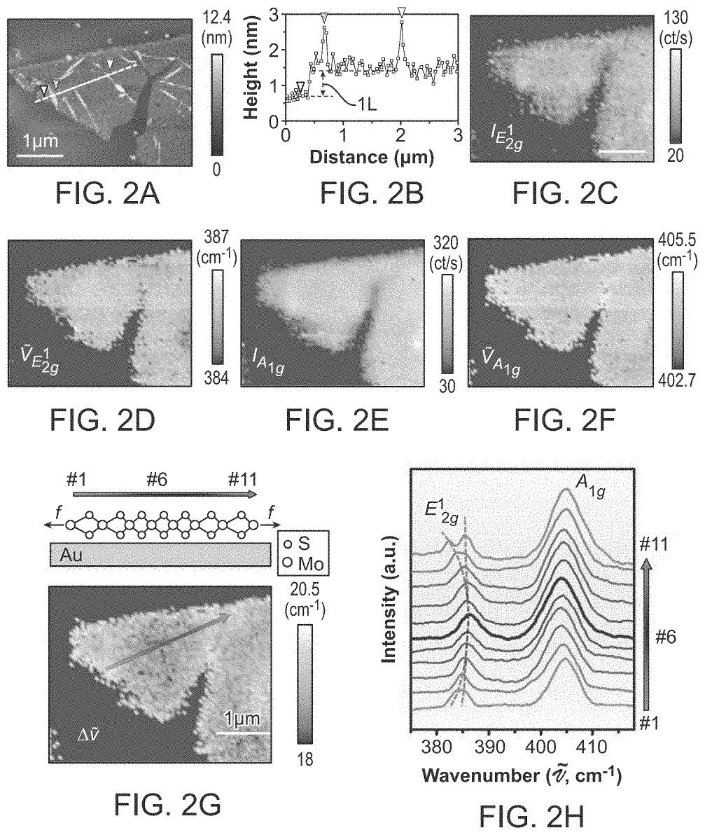

In accordance with an exemplary embodiment, the MoS₂ flake was prepared by a standard chemical vapor deposition (CVD) method on a silicon dioxide substrate and transferred onto an ultra-smooth Au thin-film substrate using the capillary-force-assisted clean-stamp transfer technique recently developed. The flexible PDMS transfer substrate hosting the MoS₂ flake was gently bent before releasing the flake to the Au substrate, to apply a tensile stress on the flake. FIG. 2(a) shows the topographic image of the MoS₂ flake measured with the RE-TERS probe in contact-mode. The stressed MoS₂ flake displayed multiple folds and cracks. The line scan in height (FIG. 2(b)) along the white dashed line demonstrates an approximately 0.8 nm film thickness, corresponding well to a MoS₂ monolayer. The root mean square (rms) roughness of the Au substrate surface was around 0.32 nm, close to that of a Si wafer. In accordance with an exemplary embodiment, the ultra-smooth Au substrates can be important for reducing the contribution of roughness-induced SERS, which could results in artifacts in gap-mode TERS imaging.

FIGS. 2(c)-2(f) are the corresponding RE-TERS intensity and Raman shift images of the two major Raman-active modes (E_{2g}¹ and A_{1g}) of MoS₂ measured from the same monolayer flake. Near the MoS₂ flake edges, the spectra intensity mapping can be as sharp as one pixel (FIG. 2(c)), indicating that the resolution of the TERS probe is at least as good as the step size (50 nm). In order to quantify the spatial resolution, a line-scan across a domain edge was performed and the error function was used to fit the intensity data. 41 nm spatial resolution is shown in FIGS. 9(a)-9(c).

In the TERS images, the E_{2g}¹ peak at 385.4±0.6 cm⁻¹ corresponds to the in-plane vibration of the two S atoms and Mo atom in opposite directions, while the A_{1g} peak at 404.1±0.5 cm⁻¹ represents the out-of-plane vibration, where the two S atoms move in opposite directions perpendicular to the basal plane. In accordance with an exemplary embodiment, the positions of the two Raman peaks are in good agreement with previous reports of monolayer MoS₂ and are consistent with the layer thickness measured with the topographical mapping. The intensity maps of the two modes (FIGS. 2(c) and 2(e)) show similar spatial variations that also correspond well with its AFM image: stronger signals were seen where the MoS₂ flake has microscale folds and weaker signal were seen where cracks are found. Such correlations between the MoS₂ morphology and TERS intensity demonstrate the optical uniformity of the ultra-smooth gold substrate. However, the Raman shift maps (FIGS. 2(d) and 2(f)) of the two modes show completely different trends. The peak position of the E_{2g}¹ mode shows consistent red-shifts towards the edges of the flakes and near the cracks, whereas the spatial variation in the A_{1g} mode frequency shows a subtler, but opposite pattern. To better visualize the trend, the frequency difference Δ\tilde{v} (Δ\tilde{v}=−\tilde{v}_{E}_{_{2g}}_{¹}) between the two modes were plotted in FIG. 2(g). Over the entire flake, Δ\tilde{v} varies from 18.2 cm⁻¹ to 20.0 cm⁻¹, with an average of approximately 18.9 cm⁻¹. While these values still fall within the monolayer regime, there is a strong spatial dependence in Δ\tilde{v}, which is approximately 1.8 cm⁻¹ larger at the edges and near the cracks of the flake than at the center. FIG. 2(h) shows a series of 11 TERS spectra collected along the red-arrow pointing from the left edge of the triangular flake to its upper right corner where it was torn due to stress in FIG. 2(g). Spectrum #6 corresponds to the middle of the arrow and the center position the center of the flake, where appears darkest in FIG. 2(g) with the lowest Δ\tilde{v}. Here, the E_{2g}¹ and A_{1g} peak positions, line shapes and their frequency difference show typical MoS₂ monolayer characteristics. However, moving towards both edges of the triangular domain (positions #1 and #11), the doubly degenerated E_{2g}¹ peak starts to soften and eventually splits into a higher frequency E⁺ mode at approximately 384 cm⁻¹ and a lower frequency E mode that is significantly red-shifted to approximately 382 cm⁻¹. According to the strain-dependence studies, the softening and splitting of the E_{2g}¹ mode can be attributed to strain-induced symmetry breaking. The reported E⁻ mode of 4.5±0.3 cm⁻¹/% uniaxial strain placed that the largest strain stored at the pinned edge of the stressed MoS₂ flake at approximately 0.9%. In comparison, the out-of-plane A_{1g} mode, which is much less sensitive to the uniaxial strain, shows only subtle differences along the red-arrow, and the slight blue-shift at the edges may originate from the stronger van der Waals (vdW) interaction between the MoS₂ monolayer and the substrate to sustain the local strain and prevent slipping. Moreover, compared with confocal Raman measurements, the TERS results tend to have stronger A_{1g} mode, which may originate from the large vertical component of the electric field (E_{⊥}) inside the gap.

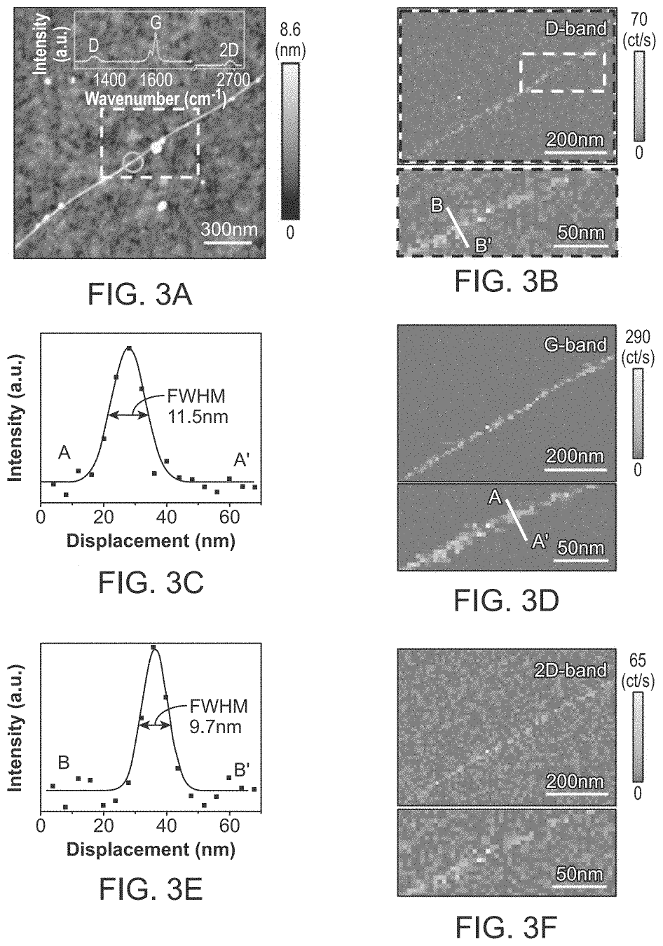

In accordance with an exemplary embodiment, to determine the spatial resolution of RE-TERS, high-resolution AFM-TERS images were acquired on a single-walled carbon nanotube (SW-CNT) sample, prepared by spraying SW-CNTs solution on an ultra-smooth gold substrate, with a step precision of 4 nm as shown in FIGS. 3(a)-3(f). As depicted by a representative spectrum (FIG. 3(a) inset), typical SW-CNT features including scattered D-band, strong G-band, and 2D-band are observed. The spectroscopic images at these bands are illustrated in FIGS. 3(b), 3(d), and 3(f), respectively. It is worth noting that the G-band intensity mapping has relatively stable signals along the CNT throughout the scanning. Such signal stability may benefit from the separation of the light coupling region at the AgNC and the Raman excitation region at tip apex, which generates a relatively stable plasmonic hotspot. Meanwhile in a conventional gap-mode TERS, the gap-SPP coupling efficiency at the tip apex is influenced by the optical index of the sample, leading to an unstable TERS signal. As shown in FIGS. 3(c) and 3(e), a 10 nm resolution can be achieved on the G-band and D-band, which is close to the instrumental limit.

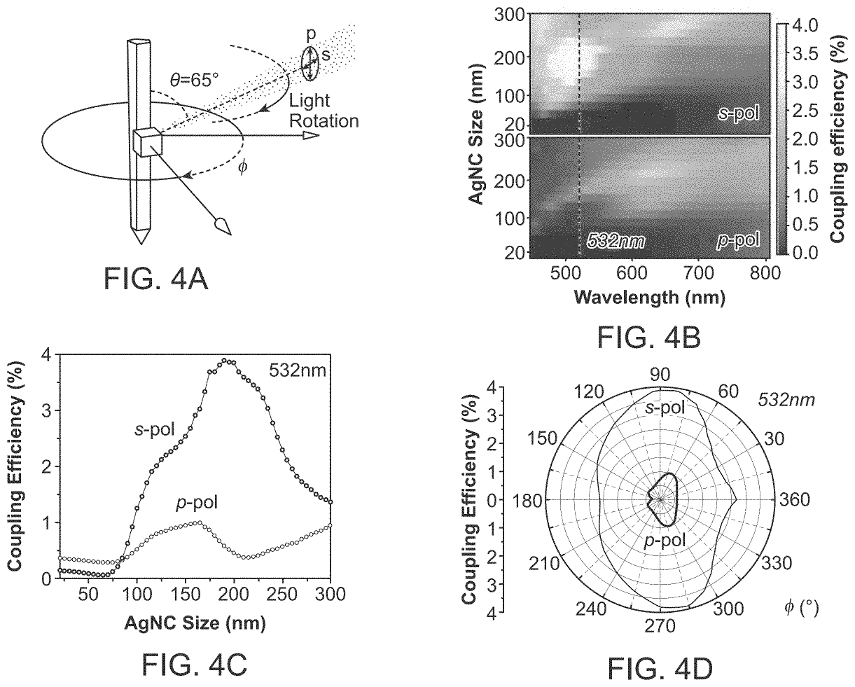

The coupling efficiency from the far-field excitation to the AgNW SPP modes has strong dependence on the coupling conditions, including the size of the AgNC and the wavelength, polarization and coupling angle of the incident laser. Finite element analysis (FEA) simulations using commercial software (COMSOL Multiphysics) was implemented to study the influence of the afore mentioned effects to optimize the coupling efficiency, which is defined as the ratio between the electromagnetic energy flux propagating along the AgNW and the power of incident beam. FIG. 4(a) illustrates the parameters used in the simulation. The incident angle (θ) of 65° with respect to the AgNW is pre-defined by the equipment, and therefore kept constant in the simulation. The azimuth angle θ is defined as the angle between the normal direction of the AgNW sidewall that is attached to the AgNC and the projection of the polarized Gaussian beam (beam waist=1 μm) incidence direction. Because the AgNW has a pentagonal cross-section, its sidewalls are flat {100} facets and allow the AgNC to sit with one face in complete parallel with one of its sidewalls. As shown in FIG. 4(b), the s-polarization excitation (electric field perpendicular to the AgNW axis) generally gives higher coupling efficiency than the p-polarization, in particular near 532 nm wavelength, which benefits from the strong plasmonic enhancement of AgNWs in response to the s-polarization. For 532 nm excitation (FIG. 4(c)), the optimized AgNC size around 200 nm gives coupling efficiency near 4%, which is about 4 times higher than that of p-polarization. The azimuthal angle dependence study in FIG. 4(d) reveals that the coupling efficiency varies between approximately 2% to 4% when the incident light is focused on the AgNW-AgNC junction from different directions (ϕ), providing a robust fabrication tolerance when attaching the bundle to the AFM cantilever.

In accordance with an exemplary embodiment, the chemical sensitivity of a TERS probe in the direct-excitation configuration is typically characterized by the enhancement factor (EF), as given by the following equation:

$$E F = ( \frac{{I}_{e n g a g e d} - {I}_{retracted}}{{I}_{retracted}} ) \frac{{A}_{background}}{{A}_{T E R S}}$$

where I_{engaged} and I_{retracted} are Raman peak intensities measured with the tip in contact and retracted, A_{background} is the area of the excitation laser spot, and A_{TERS} is the effective area of the TERS enhancement region, giving that the molecular density is a constant during the measurement. The difference between I_{engaged} and I_{retracted} is the Raman signal generated due to the tip enhancement, or I_{TERS}=I_{engaged}−I_{retracted}. It can be seen from this equation that molecules under the direct laser excitation will contribute to I_{retracted}, but only those under the nano-sized TERS spot, which depends on the tip radius and tip-substrate distance, will contribute to the TERS signal (I_{TERS}) that has nanoscale spatial resolution. Therefore, most of the molecules within the excitation laser spot become part of the background which limits both the TERS sensitivity and the spatial resolution. In remote excitation configuration, however, this diffraction-limited background is suppressed, because the laser focus is vertically separated from the scanning region, and the far-field radiation density reaching the detection spot is therefore reduced. This has been observed in other remote-excitation configurations, including grating couplers. Apart from background suppression, the RE-TERS can also produce stronger signal compared to the conventional direct-excitation (DE) configuration under the same incident power. Although not yet experimentally demonstrated, the signal enhancement is theoretically possible when the power of optical excitation injected into the near-field region through the SPPs outweighs the antenna effect of the tip in DE-TERS, with the apex capturing light over a cross-section exceeding its geometric dimensions. Nevertheless, this requires efficient optical coupling and low propagation loss of the RE-TERS configuration, which has been challenging to achieve.

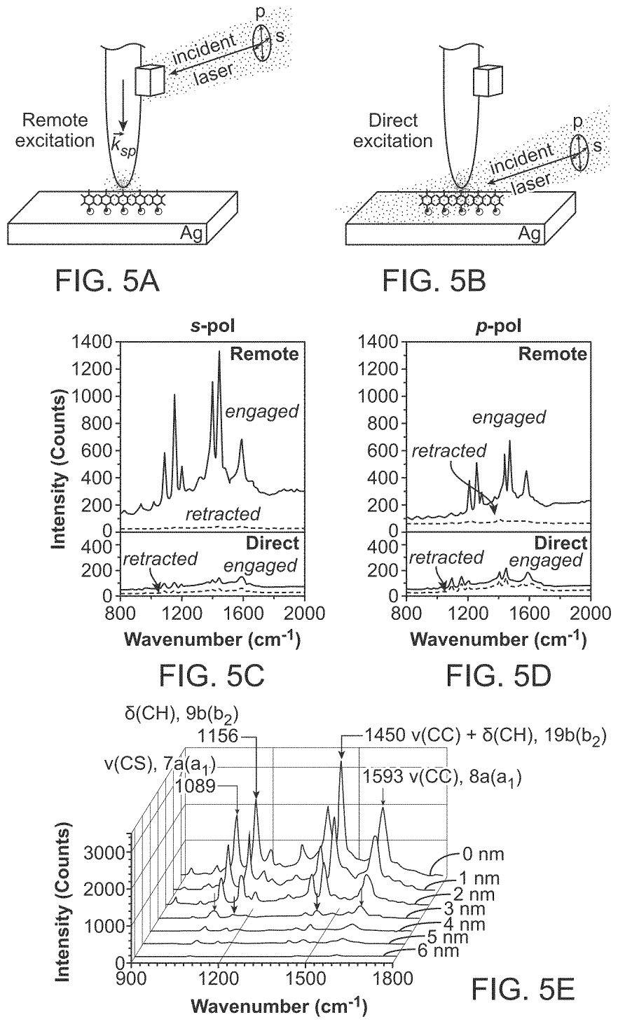

In the comparative characterization of the RE- and DE-TERS shown in FIGS. 5(a)-5(e), it has been demonstrated that the AgNC-AgNW based RE-TERS probe can provide the benefit of both background suppression and signal enhancement, thus significantly improve the TERS contrast. FIGS. 5(a)-5(b) illustrate the RE- and DE-TERS measurement configuration. The same probe and laser power (6 mW) were used for all the measurements in FIGS. 5(a)-5(e). In the RE-TERS experiment, the incident laser is focused on the AgNC, whereas in DE-TERS, the laser is focused directly on the AgNW tip. To help ensure substrate and sample homogeneity, a self-assemble monolayer (SAM) of 4-aminothiophenol (4-ATP) on an ultra-smooth Ag thin film was used as the standard sample. The ultra-smooth Ag thin film was fabricated following the same protocol as the Au-thin film in FIGS. 2(a)-2(h). With both s- and p-polarized incident light, the background (I_{retracted}) is significantly reduced in RE-TERS, with a background reduction ratio (I_{retracted,RE}/I_{retracted,DE}) of 0.26 and 0.52, respectively. Similarly, for both polarizations, enhancement of the TERS signal in RE opposed to DE excitation were observed, featuring a signal enhancement ratio (I_{engaged,RE}/I_{engaged,DE}) of 12.2 (s-pol) and 3.3 (p-pol). Both calculations are based on the Gaussian fitting of the 1446 cm⁻¹ peak. The signal enhancement from more efficient power injection than tip-scattering and the background reduction from the separation of the excitation and detection spots work synergistically to significantly increase the TERS contrast. Compared to the EF, the calculation of which is often based on many estimations, the TERS contrast, given by

$$C = \frac{{I}_{e n g a g e d}}{{I}_{r e t r a c t e d}} ,$$

is based purely on experimental data and is a direct measure of the signal increase by the tip and the image quality that can be obtained in a TERS experiment. Therefore, C is of more practical relevant and has been adopted as the industrial standard for benchmarking the performance of TERS probe. Here, a C_{RE-TERS}˜100 for the s-polarization was seen, which is enhanced from that of the same probe in the DE-TERS configuration by approximately 47-fold. Even for the p-polarization that is not optimized for RE-TERS coupling, a 6-fold increase was still seen in TERS contrast with a C_{RE-TERS} approximately (˜) 20.

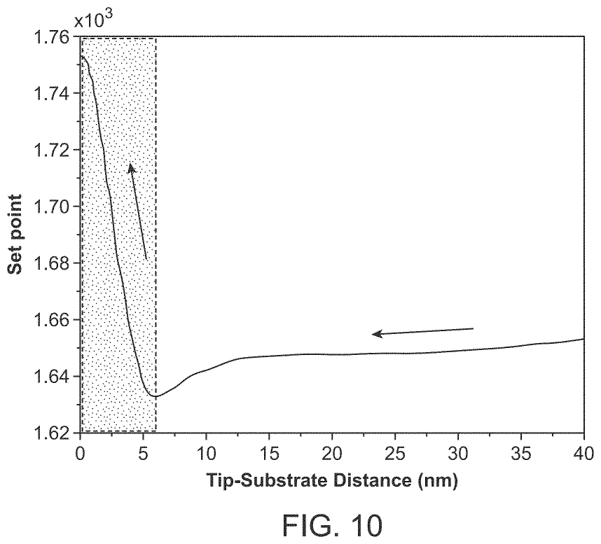

FIG. 5(e) shows RE-TERS spectra as a function of tip-substrate distance (d) for 4-ATP SAM on ultra-smooth Ag thin film using an incident laser power of 6 mW at λ=532 nm (0.2 mW at sample surface). The tip was first brought in contact with the substrate (define as 0 nm), then the tip was gradually lifted by adjusting the set point in the feedback system of the contact mode AFM (FIG. 10). The TERS signal dropped drastically when the gap distance increased beyond 2 nm and barely showed any Raman signature of 4-ATP at 6 nm, clearly demonstrating the near-field origin of the signal. It was noted that although positions of the major Raman peaks stay constant at different gap distance, the relative peak intensity changed noticeably. At larger tip-substrate distances (>2 nm), the 1089 cm⁻¹ peak corresponding to C-S stretching (v(CS), 7a) and the 1593 cm⁻¹ peak corresponding to C═C stretching (v(CC), 8a) are the dominating peaks, as marked by the purple arrows in FIG. 5(e). Both vibrations belong to a₁ symmetry of the 4-ATP, which has a C₂ᵥ symmetry point group. This is consistent with the surface selection rule, which dictates that for an adsorbed molecule with C₂ᵥ symmetry and its C₂ axis perpendicular to the metal surface, the electromagnetic enhancement should obey the relationship of a₁>b₂, b₁>a₂. However, for small tip-substrate distances (≤2 nm), the vibrations with b₂ symmetry at 1156 cm⁻¹ (δ(CH), 9b) and the 1450 cm⁻¹ (v(CC)+δ(CH), 19b) quickly grow stronger than the a₁ peaks. Such strong anomaly has been previously observed in systems with tight optical confinement, such as hollow plasmonic nanoparticles or nanogaps, and can be attributed to the chemical enhancement effects, such as photoinduced charge transfer through the Herzberg-Teller contribution. FIG. 5(e) demonstrates the dependence of the “b₂ enhancement” on the gap size or the degree of confinement.

In accordance with an exemplary embodiment, using AgNCs with proper size as an efficient plasmonic antenna to convert the excitation laser beam into the surface plasmon polaritons on a sharp-tip AgNW waveguide, it has been demonstrated the remote-excitation of tip-enhanced Raman spectroscopy with high TERS contrast (up to 100) and fine spatial resolution (41 nm). In accordance with an exemplary embodiment, the Raman scattering variation was mapped within a MoS₂ flake, which reveals the strain distribution stored during the transfer process. The RE-TERS probes can be fabricated through a facile, robust and reproducible method, which requires only economical benchtop techniques. This polarization-insensitive antenna design allows the choosing of laser polarization that has weak interaction with the sample substrate for the further reduction of background noise. In accordance with an exemplary embodiment, it is expected that the remote-excitation plasmonic probe as disclosed offers new routes for applications in disciplines where high resolution and sensitivities are needed, for example, in near-field scanning optical imaging and sensing.

### Methods:

AgNC-AgNW Bundle Synthesis and Probe Preparation:

The AgNW solution (concentration approximately 10⁸/mL, solved in ethanol) and AgNC solution (concentration approximately 10¹¹/mL, solved in ethanol) were mixed and then incubated for 48 hrs at room temperature to form AgNC-AgNW bundles. After incubation, the top clean solution was removed and the bottom solution containing bundles was casted on a PDMS substrate and dried with nitrogen. The averaged AgNC density on an AgNW can be controlled by varying the volume ratio of AgNW and AgNC solutions, as shown in FIG. 7. The final AgNC density of approximately 0.7 μm⁻¹ (on AgNW) was used in this experiment, which gave the highest chance to find a single AgNC around approximately 2 μm to 6 μm away from the AgNW tip. The bundle samples on PDMS substrate were then examined under a dark-field optical microscope (Nikon Eclipse Ni-U, 50× objective lens) and a sCMOS camera (Zyla 5.5, Andor). With proper contrast settings in the camera, the AgNCs can be identified from the AgNW. A sharp tungsten probe controlled by a high-precision motorized micromanipulator (Sutter Instrument Co.) was then used to gently wipe along the selected AgNW to remove the unnecessary AgNCs from the AgNW, then pick it up and mount onto the side wall of a conventional silicon AFM cantilever (Olympus, Model #AC160TS-R3). The prepared probe was usually used within three days of fabrication to avoid oxidization.

TERS Measurement:

The TERS measurement illustrated in FIG. 1(a) was carried out on an OmegaScope™ 1000 (AIST-NT) platform, which is integrated with a Horiba confocal Raman microscope (LabRAM HR Evolution). The 532-nm laser beam (OPUS 532, Laser Quantum) was sent through two tandem laser line filters, a quarter-λ wave plate, and a linear polarizer to generate a s-polarized beam. A high NA objective lens (Mitutoyo, M Plan Apo 100×, NA=0.7) was used to focus the off-axis excitation beam onto the AgNC-AgNW junction and collect the Raman scattering from the AgNW sharp tip. The contact-mode AFM was used to perform the TERS measurement in ambient conditions.

Numerical Simulation:

Electromagnetic simulations were carried out using a commercial finite element analysis software (COMSOL Multiphysics). The AgNW diameter was 200 nm and the AgNC size was swept from 20 nm to 300 nm. The tip radius of the AgNW was 5 nm and the gap between AgNC and AgNW was set at 2 nm, to include the influence from Polyvinylpyrrolidone (PVP) molecules. The distance from the AgNW-AgNC junction to the AgNW tip was 2 The silver permittivity was obtained from fitting the Drude model from Johnson and Christy.

### Coupling Efficiency Measurement

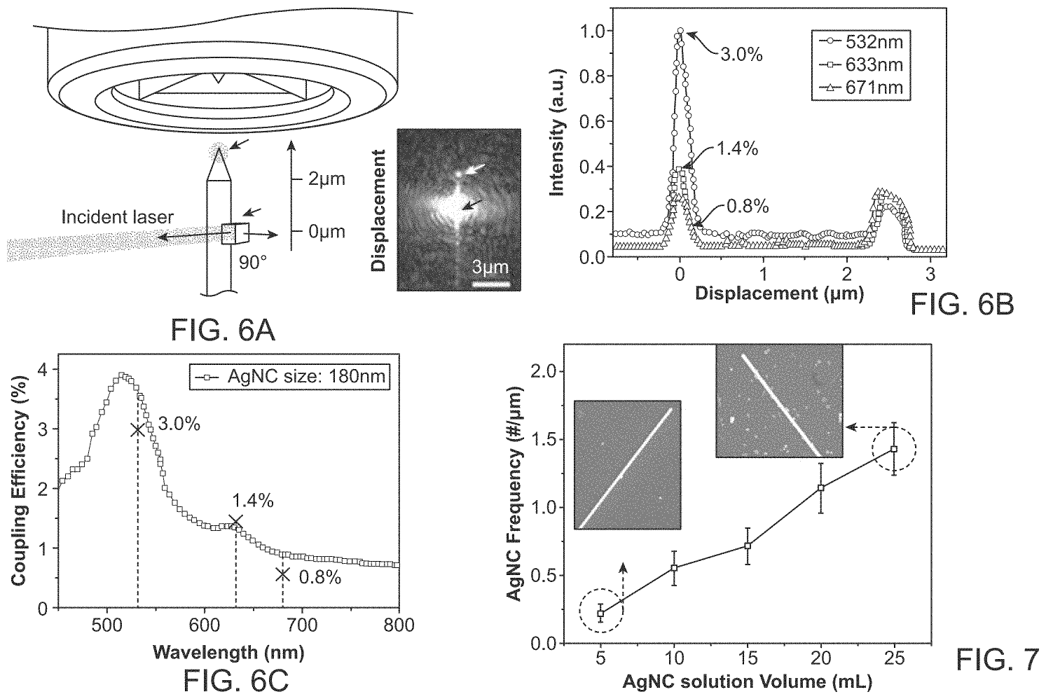

In accordance with an exemplary embodiment, to demonstrate the high coupling efficiency of the proposed remote-excitation probe, the experiment illustrated in FIGS. 6(a)-6(c) was designed to compare the coupling efficiency of the AgNC-AgNW junction with the direct scattering efficiency of a bare AgNW tip. A freshly prepared AgNC-AgNW bundle was mounted under an optical microscope for the measurement, with the AgNW axis perpendicular to the specimen plane of the objective lens (Nikon Eclipse Ni-U, 50× objective lens, NA=0.6). Only the AgNW tip was placed under focus, forming a clear spot in a large-dynamic-range charge-coupled device (CCD) camera (16 bit, Zyla 5.5, Andor), which was used to estimate the radiation power from the AgNW tip. The AgNC-AgNW junction that was approximately 2.5 μm away from the AgNW tip was greatly defocused on the CCD camera due to the shallow image depth of the high-NA objective lens, and therefore the scattered light from the AgNC-AgNW junction could be neglected. A tapered optical fiber (tip apex approximately 200 nm) mounted on the micromanipulator was used to mimic the focused light beam for the side-illumination, as shown in previous work. The radiation power dependence on the excitation locations is shown in FIG. 6(b). The red arrow and light-blue arrow indicate the location of the AgNC-AgNW junction and the AgNW tip, at the displacement of 0 μm and 2.5 μm, respectively. In order to estimate the coupling efficiency under different wavelength of the incident laser to relate to the simulation result. In accordance with an exemplary embodiment, the 532 nm, 633 nm, and 671 nm lasers were applied and the power ratio between the junction-coupled SPPs and the direct scattering from AgNW tip were around 4.4, 1.4, and 0.9, respectively.

In accordance with an exemplary embodiment, the coupling efficiency can be estimated by comparing the radiation power from the AgNW tip with the total power from the tapered optical fiber. After placing the optical fiber perpendicular to the specimen plane to measure the total power with the CCD camera, the coupling efficiency of the AgNC-AgNW junction was estimated to be about 3.0%, 1.4%, and 0.8% under excitation of 532 nm, 633 nm, and 671 nm, respectively. It worth to note that the output power of each laser source is not same, the 532 nm laser was used as the reference 1 and normalized the 633 nm, and 671 nm laser power. FIG. 6(c) shows the comparison between simulated coupling efficiency and estimated coupling efficiency.

### AgNC Density Control

In accordance with an exemplary embodiment, the AgNC density on AgNWs can be controlled by varying the initial volumes of AgNC solutions used in the incubation. Since after incubation both AgNCs and AgNWs concentrate at the bottom of the tube, the larger initial volume of AgNC solution gives relatively higher particle concentration. FIG. 7 shows the AgNC frequency, in the unit of through the statistic of the average of 20 AgNWs for each data point. The AgNCs were solved in ethanol, with the particle density of 10¹¹/mL. The AgNWs were also solved in ethanol, at the density of 10⁸/mL. 5 mL of AgNW solution and various amount of AgNC solution (approximately 5 mL to 25 mL) were incubated in a 50 mL polypropylene conical centrifuge tube for 48 hours, with the cap sealed to prevent solvent evaporation. The results were then cast on silicon substrates, dried by nitrogen, and counted under SEM. 20 (twenty) nanowires from each concentration were used to estimate the AgNC frequency and the statistic error.

Removing Excessive AgNCs from a AgNW

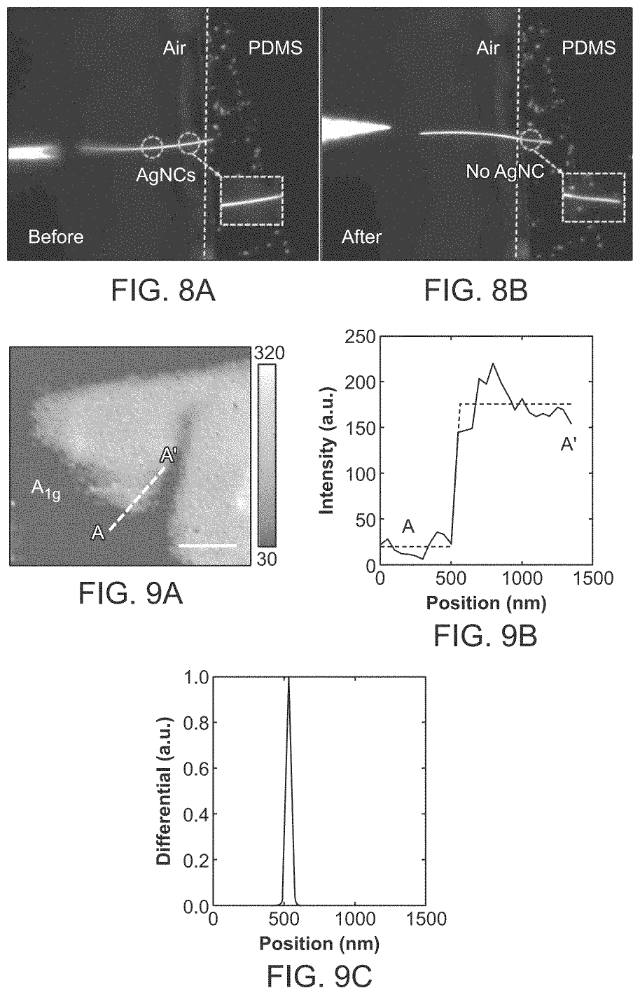

Since only the closest AgNC to the AgNW tip serves as the coupler, the rest of AgNCs are not needed in the probe. On the other hand, these excessive AgNCs can potentially reduce both the adhesion force and the friction force between the AgNW and the cantilever, making the probe more vulnerable to sliding along the cantilever during scanning. Therefore, removing the unneeded AgNCs from the bundle is necessary. Benefiting from the weak adhesion between AgNC and AgNW, they can be easily removed by simply wiping a tungsten tip along the nanowire. FIGS. 8(a) and 8(b) shows the process. The AgNC-AgNW bundle is mounted on the edge of a PDMS substrate here for better optical image quality. Examined under dark-field optical microscopy with proper contrast parameters used in the CCD camera, the AgNCs can be located on the AgNW. A sharp-tip tungsten probe mounted on a motorized micro-manipulator was used to remove the AgNCs (FIG. 8(b)).

### Spatial Resolution of the MoS₂ TERS Imaging

In accordance with an exemplary embodiment, the step-edge (or knife-edge) resolution calculation method was used to estimate the spatial resolution of the TERS mapping. FIG. 9(a) shows the Mg peak intensity mapping of a monolayer MoS₂ flake, with a sharp edge chosen for the resolution estimation in FIG. 9(b). The Gauss error function was used to fit the step-like cross-section, and the spatial derivative of the fitted data in FIG. 9(c) gives a full width at half maximum (FWHM) of approximately 41 nm.

### Control of the Tip-Substrate Distance

FIG. 10 shows the relationship between contact mode AFM set-point and the tip-to-substrate distance. The variable range of the set point was 1.63×10³ to 1.75×10³. By choosing different set point value from this range, the corresponding tip-to-substrate distance between 0 nm to 6 nm can be achieved.

Numerical Simulation for Comparing with and without Gap Mode

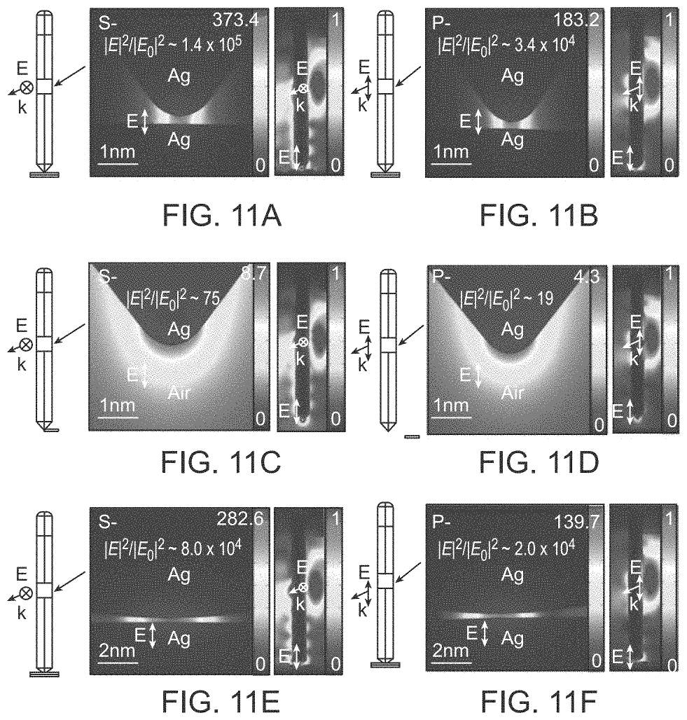

In accordance with an exemplary embodiment, a commercial finite element analysis software (COMSOL Multiphysics) has been utilized to investigate the coupling efficiency, with the results shown in FIGS. 11(a)-11(f). The z-component of electrical field distribution are depicted with three configurations: sharp-tip AgNW (5 nm diameter the apex) with and without metal substrate, and a regular AgNW (50 nm diameter the apex) with the silver substrate. Both s- and p-polarization excitation light with 532 nm in wavelength were examined. FIGS. 11(a)-11(f) shows that the strongest intensity enhancement is achieved in the sharp-tip AgNW case with metal substrate and s-polarization excitation, which results in an intensity enhancement of approximately 1.4×10⁵.

### AgNW Quality Checking Control Using Dark-Field Optical Microscopy

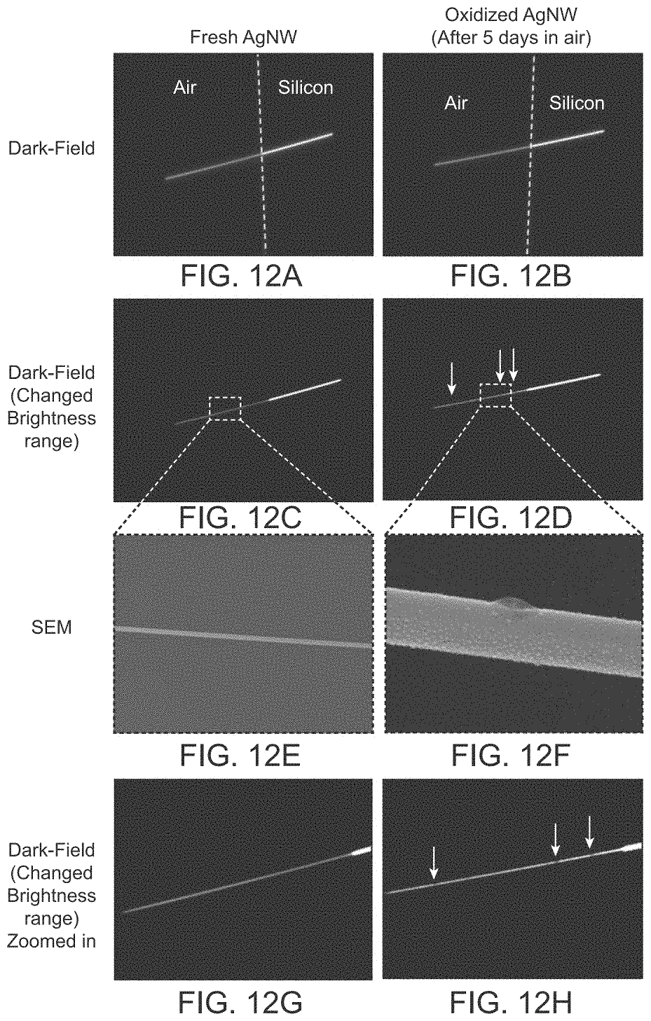

Dark-field optical microscopy is used to conclude the quality of silver probes, and investigate the oxidization process, as shown in FIGS. 12(a)-12(h). The dark-field optical image of an AgNW put on the edge of a silicon wafer was recorded by an s-CMOS camera (16 bit, Zyla 5.5, Andor) on Day 0 and Day 5 for the comparison of AgNW quality, as shown in FIGS. 12(a) and 12(b), respectively. The large dynamic range of the camera allows to set proper thresholds to highlight the inhomogeneity along the oxidized AgNW at Day 5 (FIG. 12(d)), which was absent on the freshly-prepared AgNW on Day 0 (FIG. 12(c)). It is worth noting that the fresh AgNW was firstly examined under SEM (FIG. 12(e)) before the aging process to confirm its smoothness. While for the same AgNW, clear oxidization of the AgNW was found at the location where the darker scattering was observed. FIGS. 12(g) and 12(h) show the zoom-in of the free-standing AgNW region, and the aging-induced defects are clearly seen, as indicated by the red markers, which criteria has been used in selecting the proper AgNW for the TERS probes.

### Probe Reproducibility: Size Control of AgNCs

To prove the reproducibility of the RE-TERS probe fabrication, the three key parameters that determine the plasmonic performance of a prepared probe were analyzed, and five probes were prepared to show the low probe-to-probe variations using this method. The three key parameters include: the AgNC size distribution, the AgNW diameter distribution, and the protruding length of AgNWs.

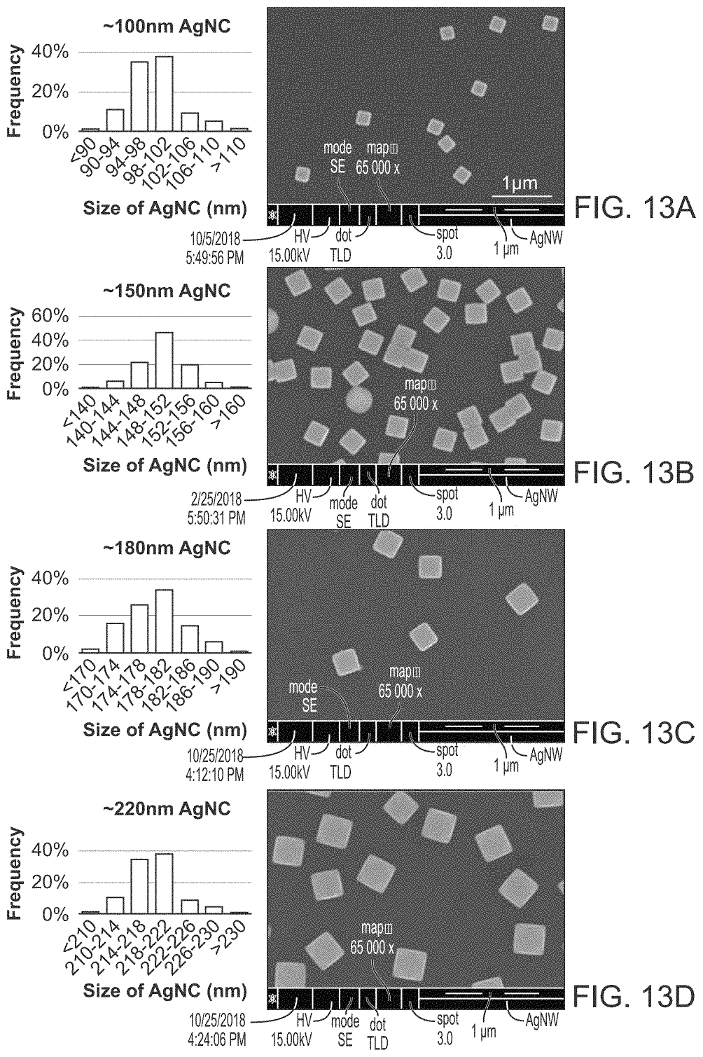

Nanoparticle sizes were controlled by varying the reaction time while maintaining concentrations and feeding rates of AgNO₃ and PVP constant throughout the synthesis process. In accordance with an exemplary embodiment, the size distribution was controlled within 20 nm even with large AgNCs. By counting, for example, approximately 200 AgNCs to 300 AgNCs for each size in SEM images, the dimension distribution of different sized AgNCs could be shown in FIG. 13(a)-13(d). In accordance with an exemplary embodiment, the size of approximately 80 nm AgNC is the best for the RE-TERS probe fabrication.

### Probe Reproducibility: Diameter Distribution of Sharp-Tip AgNWs

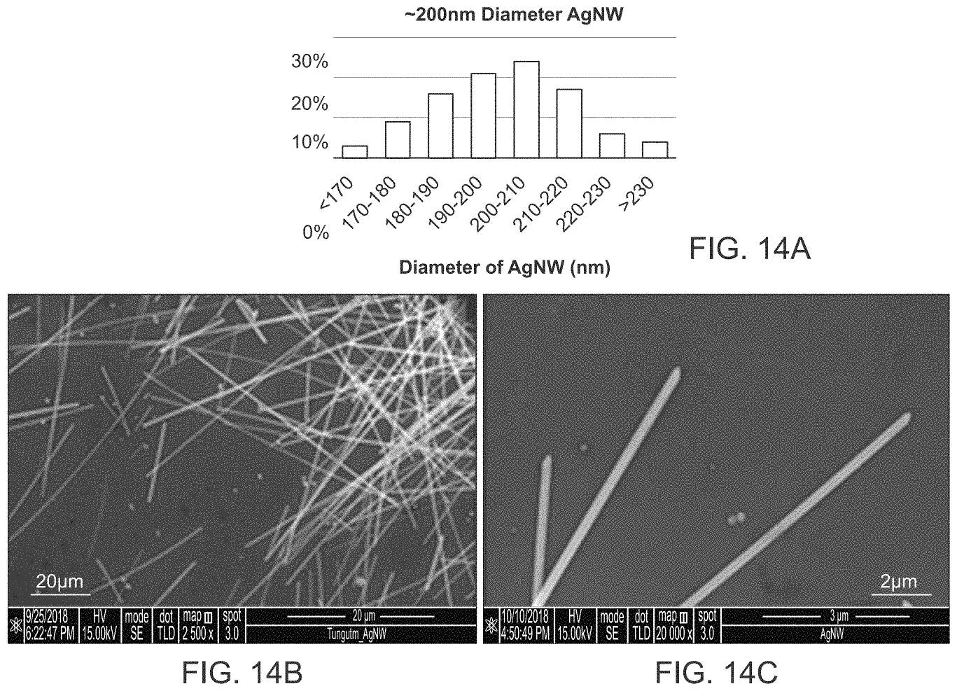

The diameter of the sharp-tip AgNWs can be controlled by varying the seeding time. FIG. 14(a) shows the dimension distribution of (nominal) 200 nm-in-diameter AgNWs. In accordance with an exemplary embodiment, the size distribution was controlled within ±15 nm. In accordance with an exemplary embodiment, for example, the conical tip can be tapered to an ultra-sharp apex having a tip radius of approximately 5 nm to 15 nm. The SEM image (FIGS. 14(a) and 14(b)) shows the productivity and quality of the sharp-tip AgNWs.

### Probe Reproducibility: Protruding Length Control

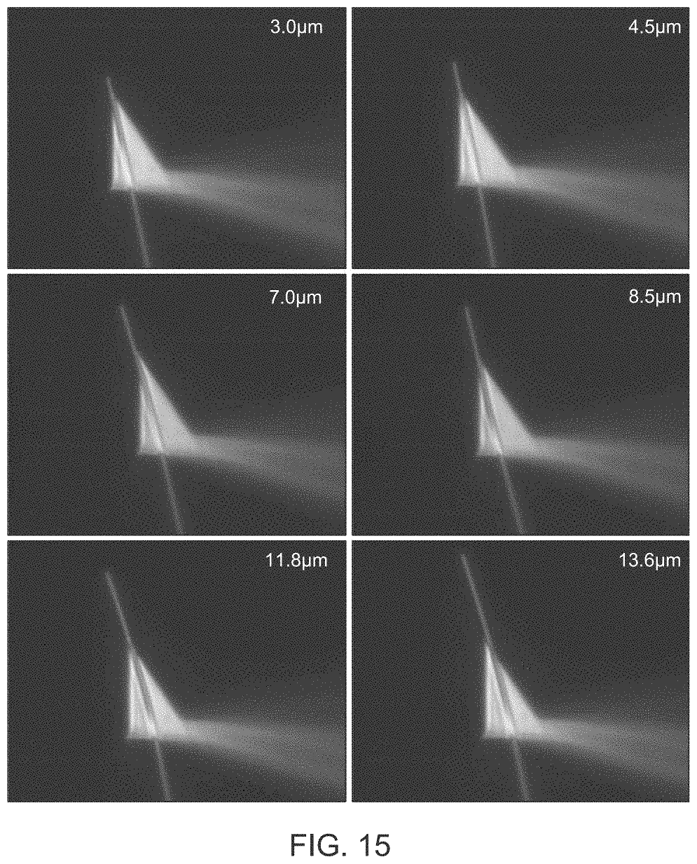

As described in the disclosure, one advantage of the proposed fabrication technique is the control of the protruding length, which is important in reducing thermal vibration noise, improving the stiffness of the prepared probe, and raising the fabrication yield. Similar to the AgNW-AFM fabrication reported in previous works, the protruding length of AgNW-AgNC bundle is controlled by gently sliding a tungsten probe, which is attached on a micromanipulator, along the AgNW towards the desired direction, while monitoring the protruding length through the dark-field optical microscope. FIG. 15 shows the continuous adjustment of the protruding length of one AgNW-AFM probe. It unambiguously shows the flexibility and reproducibility of the assembly step.

### Probe Reproductively: TERS Performance Examination

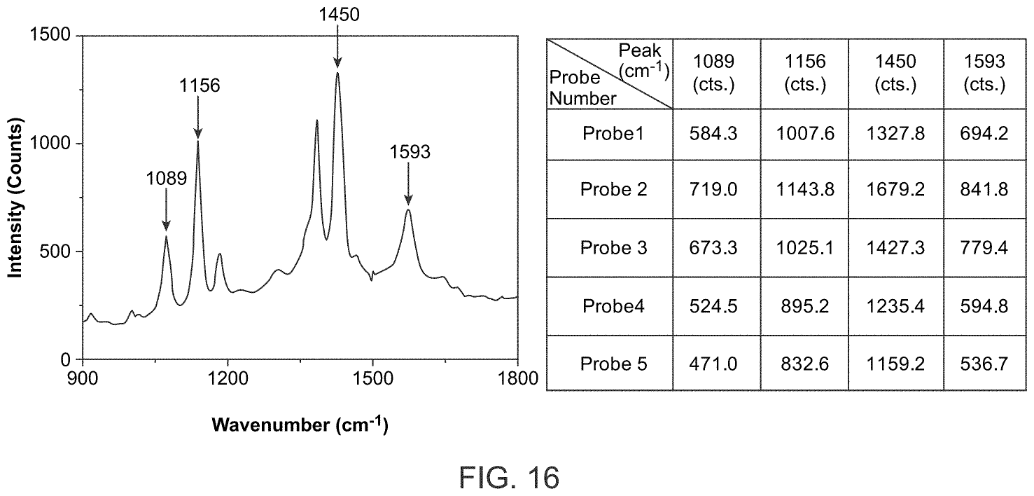

In accordance with an exemplary embodiment, five RE-TERS probes were characterized to examine the Raman enhancement performance variation. The TERS measurements were carried out on a self-assembled monolayer of 4-ATP on a silver substrate (532 nm excitation, 0.2 mW at sample surface, accumulation time was 2 second). FIG. 16 shows a representative Raman spectrum, and a list of prepared probes including their TERS performance. It is noticeable that the probe quality is relatively consistent. Taking the highest peak at 1450 cm⁻¹ for example, the standard derivation (std) of the peak intensities are 200 counts (cts.), which is about 15% of the averaged intensity (approximately 1365 cts.). Consequently, it was concluded that the probe fabrication technique is reproducible.

### MoS₂ and SW-CNT Sample Preparation

Capillary-force-assisted clean-stamp transfer method was used to transfer CVD MoS₂ monolayers from SiO₂ preparation substrates onto 100 nm-thick ultra-smooth gold surfaces. A thin (approximately 1 mm) PDMS holder was used to transfer the MoS₂. Before releasing the flakes onto the target substrate, the PDMS holder was gently stretched by approximately 10% along one direction to form uniaxial strain and then placed onto the substrate, followed by 50° C. baking for 2 mins to release the flake. The ultra-smooth gold substrates (surface roughness ˜0.32 nm) were prepared by peeling off the gold films deposited on a smooth silicon wafer by an e-beam thermal evaporator (Temescal BJD 1800 system). The deposition rate was 0.3 nm/s.

The self-assembled monolayer (SAMs) of 4-ATP on Ag film was prepared by incubating the Ag films (on Si substrate) in 20 mL 4-ATP solution (1 mM) for 24 hours. After incubation, the Ag substrate was rinsed with pure ethanol multiple times to remove the excessive 4-ATP molecules. The SW-CNT was provided by the Sigma-Aldrich Chemistry (St. Louis, United States). Dispersed 1 mL the SW-CNTs conductive aqueous ink (791480-25ML, 0.25 mg/mL) solution in 20 mL deionized water (DI water) followed by sonicated the dilute solution for 30 mins. Then sprayed the top solution using a spray gun (Paasche Airbrush) onto the pre-heated (120° C.) ultra-smooth gold substrate.

### Selective Excitation of A_{1g} Mode

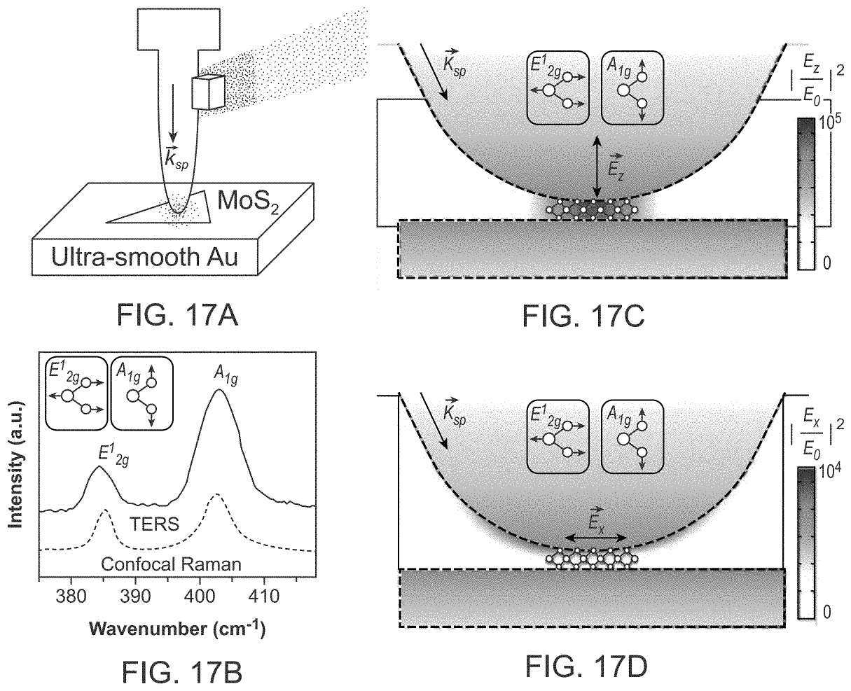

One spectral feature that was observed was the selective excitation of the A_{1g} mode in the RE-TERS spectrum compared to the far-field confocal measurement (FIGS. 17(a)-17(d). In the RE configuration (FIGS. 17(a)-17(d), the s-pol laser was focused on the AgNC excited SPPs₍ₖ_{ₛₚ}₎→in the AgNW and propagated towards its tapered tip, where they further compressed at the approximately 1 nm gap between the AgNW tip apex and the gold substrate. In this small gap, the concentrated electric field have two components, one normal (E_{⊥}) to the substrate that selectively drive the out-of-plane A_{1g} vibration in MoS₂, and the other parallel (E_{∥}) to the substrate that couples more strongly to the in-plane E_{2g}¹ vibration. According to the numerical simulation (FIGS. 17(c)-17(d), E_{⊥} is about one order of magnitude stronger than E_{∥}, giving rise to the strongly enhanced out-of-plane A_{1g} mode.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

1. A method for spatial resolution tip-enhanced Raman spectroscopy (TERS) imaging, the method comprising:
physically separating a light excitation region from a Raman signal generation region on a remote-excitation tip-enhanced Raman spectroscopy (RE-TERS) probe.

2. The method according to claim 1, wherein the RE-TERS probe includes a conical tip, the conical tip tapering to a silver nanowire tip (AgNW tip), the method comprising:
compressing surface plasmon polaritons (SPPs); and
generating a plasmonic hot spot at a tip apex of the conical tip of the RE-TERS probe.

3. The method according to claim 2, comprising:
tapering the conical tip to an ultra-sharp apex having a tip radius of approximately 5 nm to 15 nm.

4. The method according to claim 2, comprising:
exciting the surface plasmon polaritons (SPPs) with prism couplers, grating couplers, near-field coupling, and/or tip, defect and nano-antenna scattering.

5. The method according to claim 2, further comprising:
installing the RE-TERS probe on an atomic force microscopy-tip-enhanced Raman spectroscopy (AFM-TERS) system;
modifying the AFM-TERS system to enable polarization adjustment of a laser;
focusing the laser on a silver nanocrystal (AgNC) attached to a side wall of a nanowire (NW) at an incident angle of the remote-excitation tip-enhanced Raman spectroscopy (RE-TERS) probe;
propagating excited surface plasmon polaritons (SPPs) along the nanowire (NW) and compressing the excited surface plasmon polaritons (SPPs) to generate a nano-sized hot spot for tip-enhanced Raman spectroscopy (TERS) excitation; and
collecting tip-enhanced Raman spectroscopy (TERS) signals scattered by the silver nanowire tip (AgNW tip) through an objective lens.

6. The method according to claim 5, wherein the incident laser further comprising:
directing the laser through a laser line filter (LF), a linear polarizer (LP), and a beam splitter (BS) to an objective lens, the objective lens configured to focuses the laser beam on the silver nanocrystals (AgNCs) to generate the excited surface plasmon polaritons (SPPs) on the silver nanowire (AgNW) waveguide; and
propagating the surface plasmon polaritons (SPPs) toward the tapered tip to excite the TERS signals, which are collected through the objective lens, filtered by a long-pass edge filter (LEF), and collected by a CCD spectrometer.

7. The method according to claim 6, wherein the laser line filter comprises a pair of tandem laser line filters, the pair of tandem laser line filters being a quarter-A wave plate, and a linear polarizer to generate a s-polarized beam.

8. The method according to claim 7, wherein the objective lens is a high NA objective lens configured to focus an off-axis excitation beam onto the AgNC-AgNW junction and collect the Raman scattering from the AgNW sharp tip.

9. The method according to claim 1, comprising:
arranging the silver nanocrystals away from the silver nanowire tip (AgNW tip) so that the silver nanowire tip (AgNW tip) is outside a focus of the laser.

10. A method of fabricating a remote-excitation tip-enhanced Raman spectroscopy (TERS) probe, the method comprising:
fabricating the remote-excitation tip-enhanced Raman spectroscopy (TERS) probe with nanoparticles as nano-antennas to mediate coupling of free-space excitation light to propagate surface plasmon polaritons (SPPs) in a tapered-tip silver nanowire to remotely excite Raman signals.

11. The method according to claim 10, wherein the nanoparticles are colloidal silver nanocubes, the method further comprising:
attaching the colloidal silver nanocubes to a silver nanowire probe to couple visible light into the surface plasmon polaritons (SPPs) on the colloidal silver nanocubes.

12. The method according to claim 10, wherein the silver nanowires comprise:
synthesized crystalline silver nanowires.

13. The method according to claim 12, wherein the synthesized crystalline silver nanowires further comprises:
synthesizing the silver nanowires to have an ultra-sharp conical tip with nanometer-scale tip curvature.

14. A system for spatial resolution tip-enhanced Raman spectroscopy (TERS) imaging, the system comprising:
an atomic force microscopy-tip-enhanced Raman spectroscopy (AFM-TERS) system, the AFM-TERS system having a RE-TERS probe having a conical tip, the conical tip tapering to a silver nanowire tip (AgNW tip);
silver nanocrystals (AgNCs) attached to a side wall of a nanowire (NW) at an incident angle;
a laser, the laser configured to propagate excited surface plasmon polaritons (SPPs) along the nanowire (NW), the nanowire (NW) configured to generate compressed excited surface plasmon polaritons (SPPs), and wherein the conical tip of the nanowire (NW) is configured to generate a nano-sized hot spot at a tip apex for TERS excitation; and
an object lens configured to collect a TERS signal scattered by the silver nanowire tip (AgNW tip).

15. The system according to claim 14, wherein the system is configured to physically separating a light excitation region from a Raman signal generation region on the remote-excitation tip-enhanced Raman spectroscopy (RE-TERS) probe.

16. The system according to claim 15, wherein the system further comprising:
a laser line filter (LF), a linear polarizer (LP), and a beam splitter (BS) to an objective lens, and wherein the objective lens is configured to focuses the laser beam on the silver nanocrystals (AgNCs) to generate the excited surface plasmon polaritons (SPPs) on the silver nanowire (AgNW) waveguide.

17. The system according to claim 16, further comprising:
a long-pass edge filter (LEF) and a CCD spectrometer, and wherein the surface plasmon polaritons (SPPs) are propagated toward the tapered tip to excite TERS signals, which are collected through the objective lens, filtered by the long-pass edge filter (LEF) and collected by the CCD spectrometer.

18. The system according to claim 17, wherein the laser line filter comprises a pair of tandem laser line filters, the pair of tandem laser line filters being a quarter-λ wave plate, and a linear polarizer to generate a s-polarized beam.

19. The system according to claim 18, wherein the objective lens is a high NA objective lens configured to focus an off-axis excitation beam onto the AgNCs-AgNW junction and collect the Raman scattering from the AgNW sharp tip.

20. The system according to claim 14, wherein the RE-TERS probe is configured to generate a plasmonic hot spot at a tip apex of the conical tip of the RE-TERS probe.

21. The system according to claim 14, wherein the conical tip tapers to an ultra-sharp apex having a tip radius of approximately 5 nm to 15 nm.

22. The system according to claim 14, further comprising:
prism couplers, grating couplers, near-field coupling, and/or tip, defect and nano-antenna scattering, the prism couplers, the grating couplers, the near-field coupling, and/or the tip, defect and nano-antenna scattering configured to excite the surface plasmon polaritons (SPPs).

23. The system according to claim 15, wherein the silver nanocrystals are arranged away from the silver nanowire tip (AgNW tip) so that the silver nanowire tip (AgNW tip) is outside a focus of the laser.

24. The method according to claim 10, wherein the nanoparticles are dielectric particles, the method further comprising:
attaching the dielectric particles to a silver nanowire probe to couple visible light into the surface plasmon polaritons (SPPs) on the dielectric particles.
